(19) United States
(12) Patent Application Publication
(10) Pub. No.: US 2009/0080652 A1
(43) Pub. Date: Mar. 26, 2009

(54) SYSTEM AND METHOD FOR PASSWORD GENERATION AND STORAGE

(76) Inventor: Kevin Harding, Mesa, AZ (US)

Correspondence Address: PERKINS COIE LLP, P.O. BOX 1208, SEATTLE, WA, 98111-1208, US

(21) Appl. No.: 11/924,557

(22) Filed: Oct. 25, 2007

Related U.S. Application Data
(60) Provisional application No. 60/974,454, filed on Sep. 22, 2007.

(51) Int. Cl. G09C 1/00

(52) U.S. Cl. 380/56

(57) ABSTRACT

A mechanical device may have one or more user inputs and one or more password outputs to provide a plurality of secure passwords. A user may set and recover passwords by transposing one or more mechanical components of the device. A user may carry the device, but if the device is lost or stolen another individual may be unable to access any of the stored passwords.

### CLAIM OF PRIORITY

This application claims priority to U.S. Patent Application No. 60/974,454 entitled “Password Generator And Storage Device”, which was filed on Sep. 22, 2007, the contents of which are expressly incorporated by reference herein.

### BACKGROUND

Passwords are sometimes insecure. For example, a user may sometimes use an English word that is easily compromised. A more secure password may include confusing combinations of letters number and symbols. Secure passwords may be difficult to hack; however, secure passwords may also be difficult to remember.

The foregoing examples of the related art and limitations related therewith are intended to be illustrative and not exclusive. Other limitations of the related art will become apparent to those of skill in the art upon a reading of the specification and a study of the drawings.

### SUMMARY

The following examples and aspects thereof are described and illustrated in conjunction with systems, tools, and methods that are meant to be exemplary and illustrative, not limiting in scope. In some of the examples, one or more of the above described problems has been reduced or eliminated, while other examples are directed to other improvements.

A mechanical device may have one or more user inputs and one or more password outputs to provide a plurality of secure passwords. The device may be portable. Passwords may be associated with logins, and associations between the logins and passwords may be inscribed on the device to assist a user in remembering the associations.

Methods associated with the device may allow a user to set and recover passwords by transposing one or more mechanical components of the device. Many combinations of passwords may be created. Advantageously, a user may carry the device on her person, but if the device is lost or stolen another individual may be unable to access any of the stored passwords.

These and other advantages will become apparent to those skilled in the art upon a reading of the following descriptions and a study of the several figures of the drawings.

### BRIEF DESCRIPTION

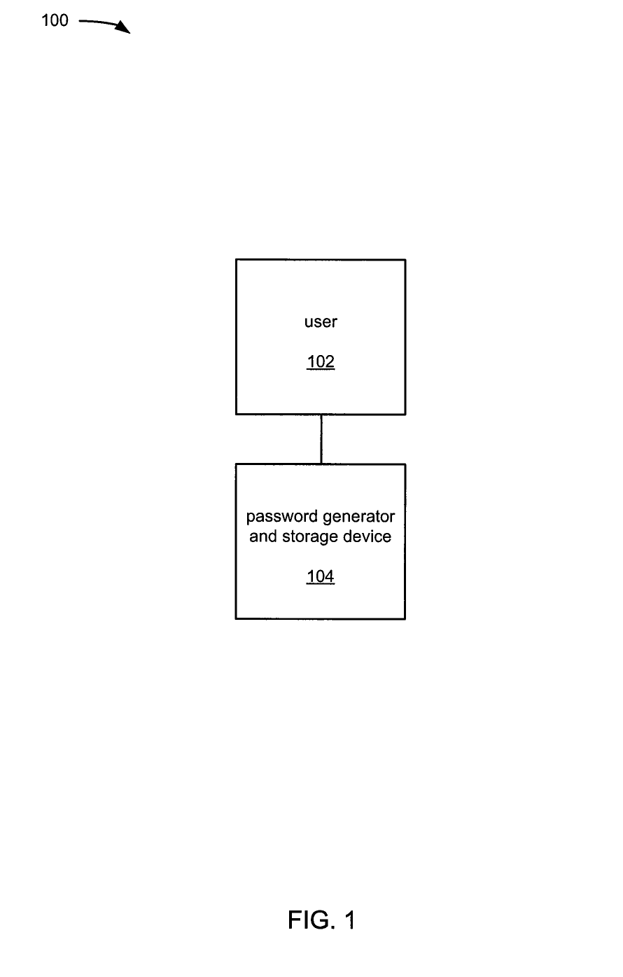

FIG. 1 depicts a diagram of an example of a system for generating and recovering passwords.

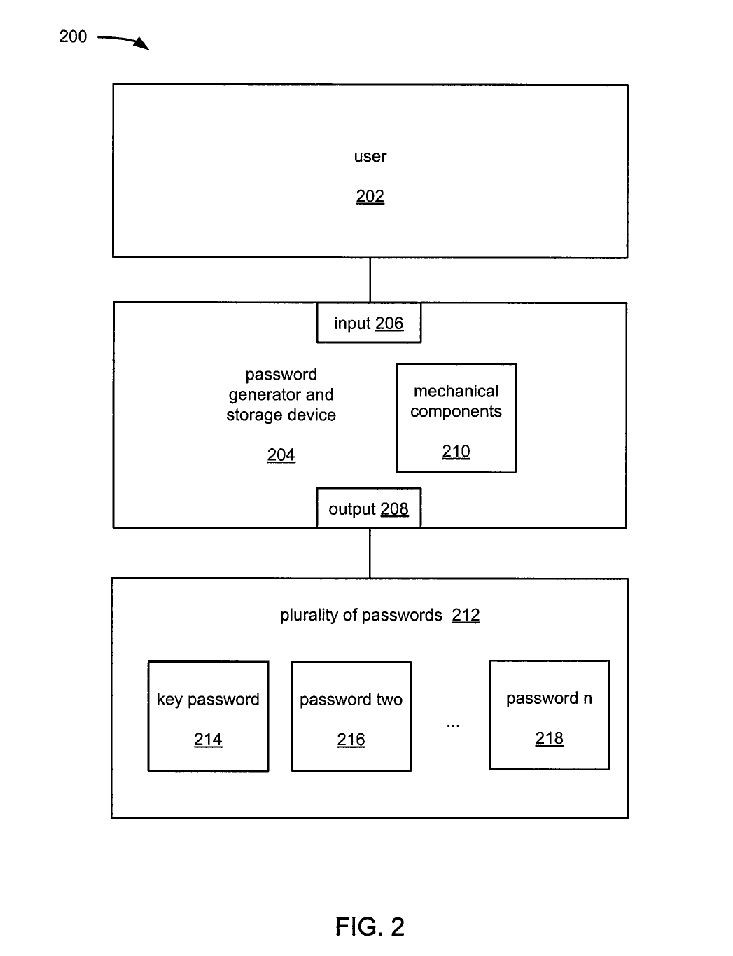

FIG. 2 depicts a diagram of an example of a device for generating and recovering passwords.

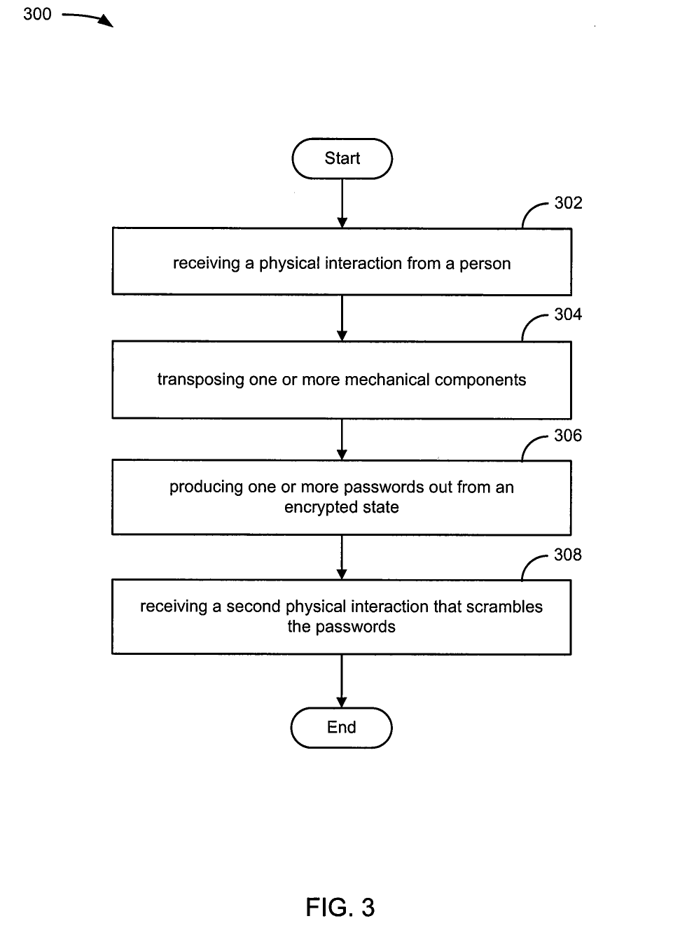

FIG. 3 depicts a flowchart of an example of a method for producing one or more passwords.

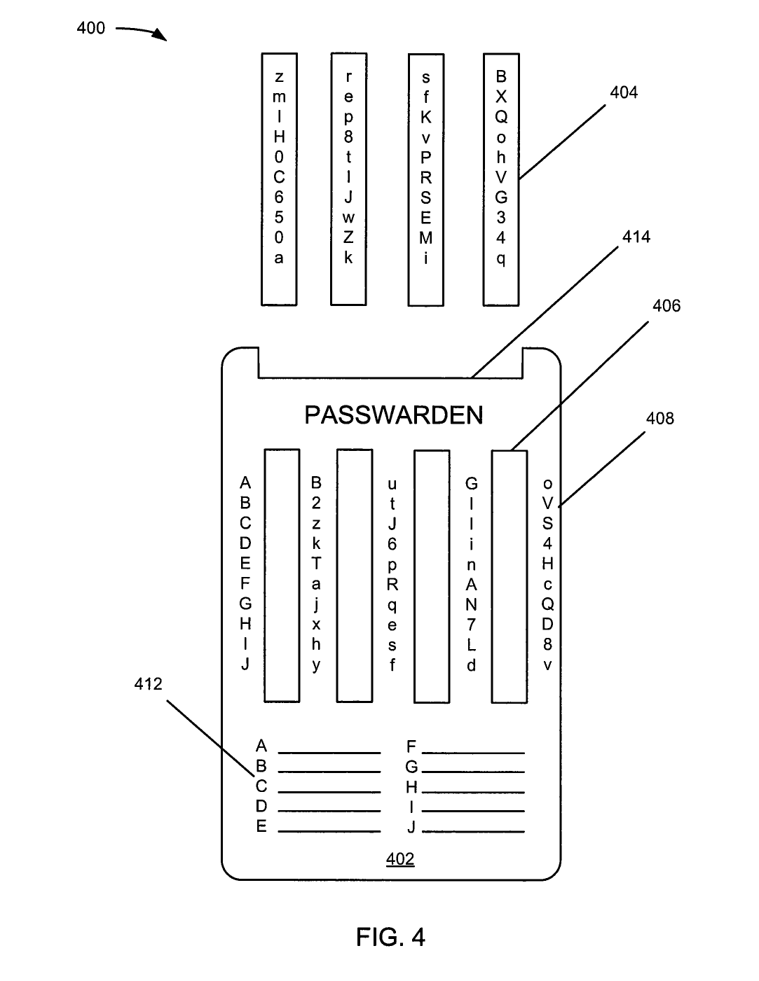

FIG. 4 depicts a diagram of an example of a device for generating and recovering passwords.

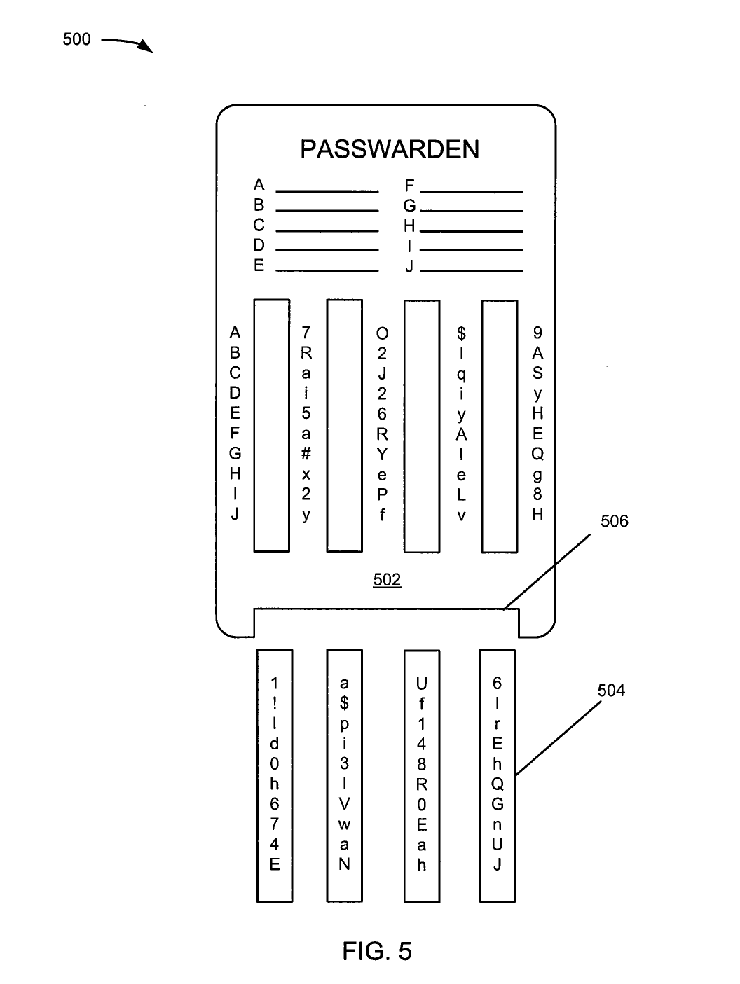

FIG. 5 depicts a diagram of an example of a device for generating and recovering passwords.

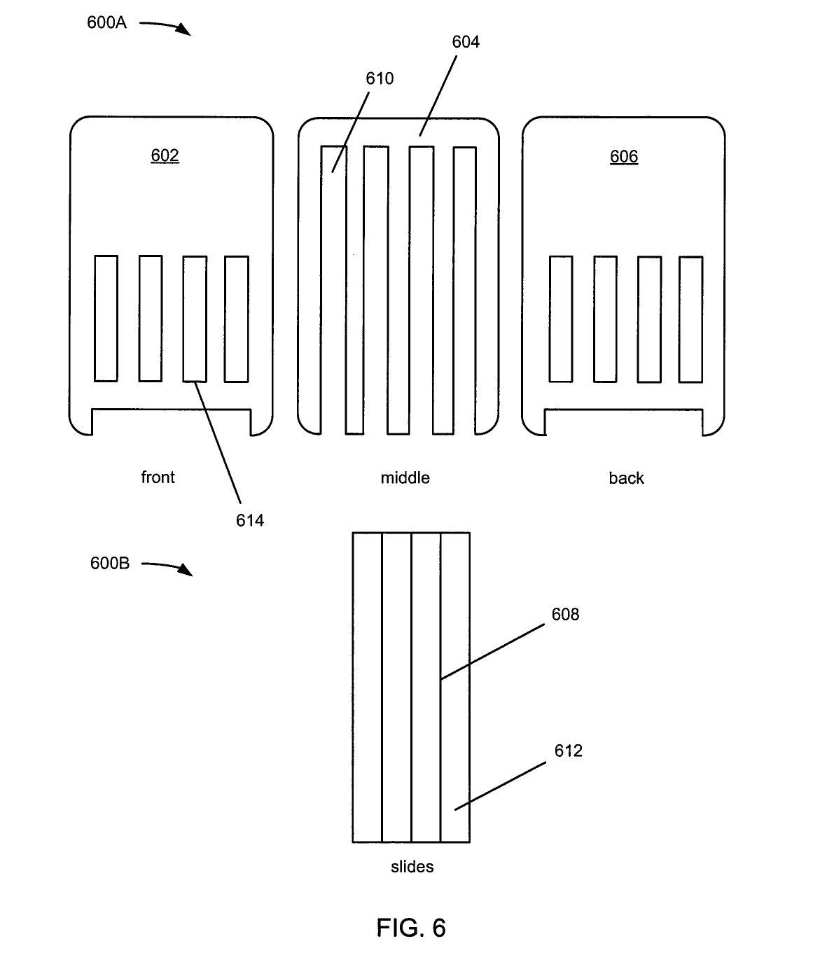

FIG. 6 depicts diagrams of examples of unassembled parts of a password generator and storage device.

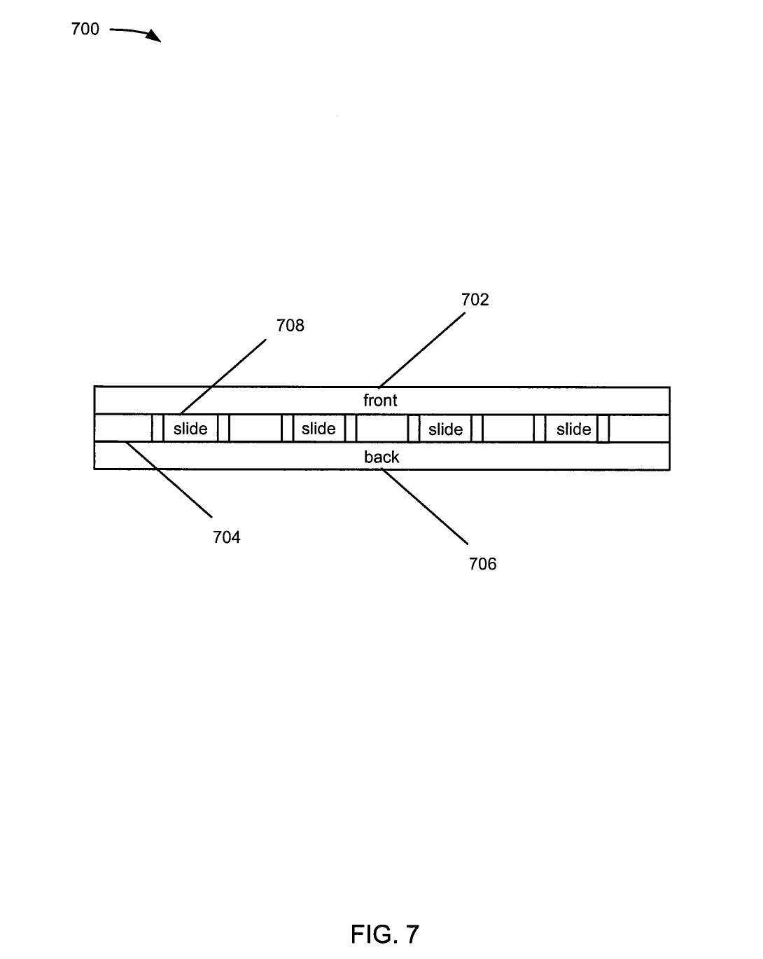

FIG. 7 depicts a diagram of an example of a side view of a device for generating and recovering passwords.

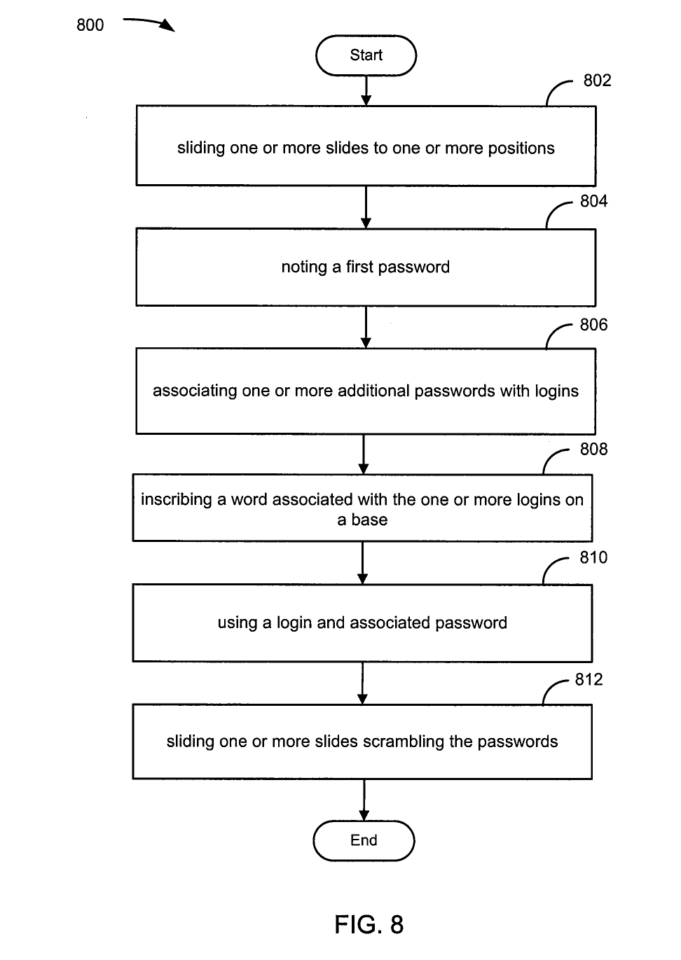

FIG. 8 depicts a flowchart of an example of a method for producing and using one or more passwords.

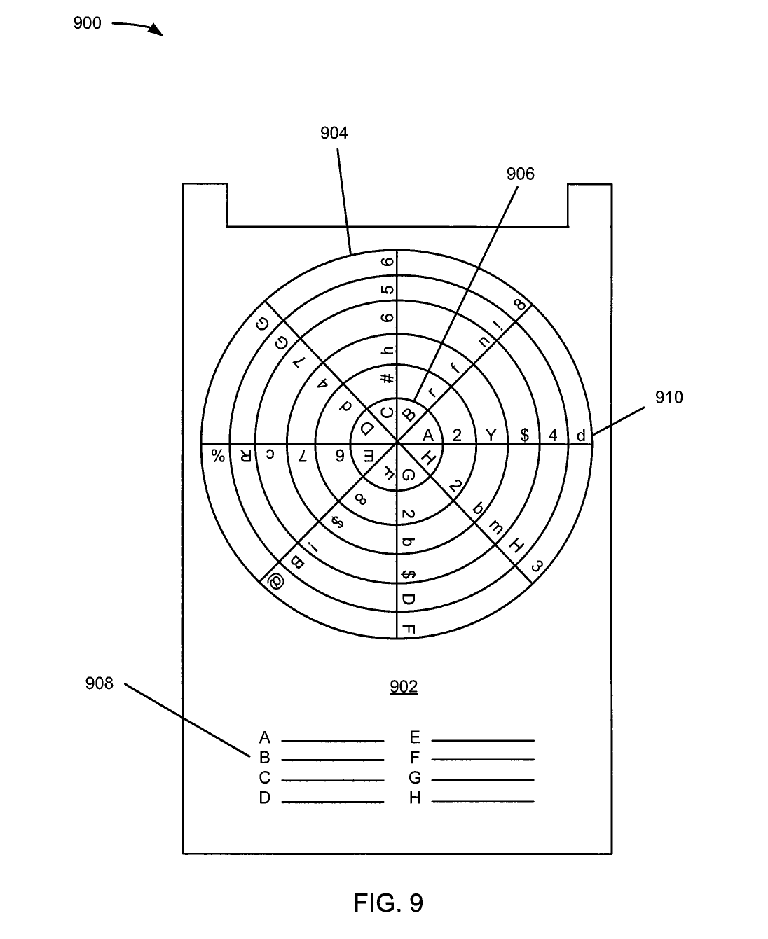

FIG. 9 depicts a diagram of an example of a device for generating and recovering passwords.

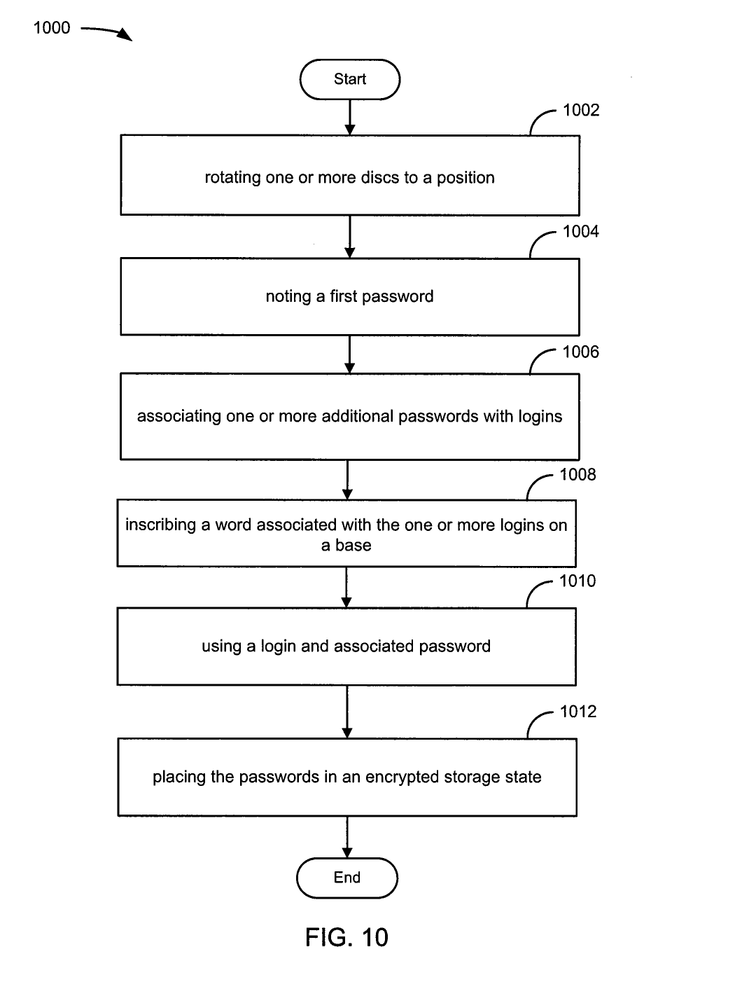

FIG. 10 depicts a flowchart of an example of a method for producing and using one or more passwords.

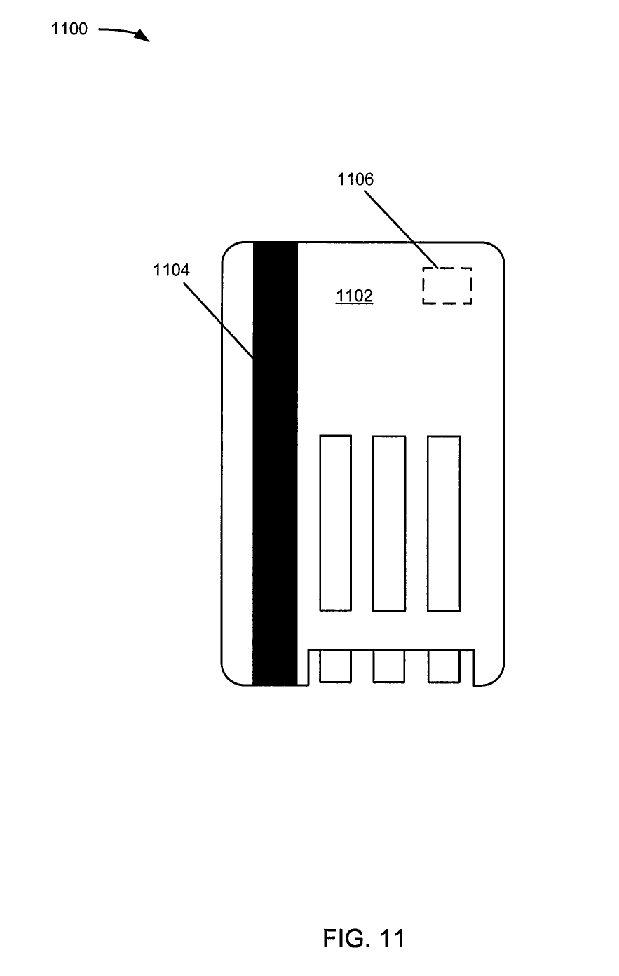

FIG. 11 depicts a device for generating and recovering passwords.

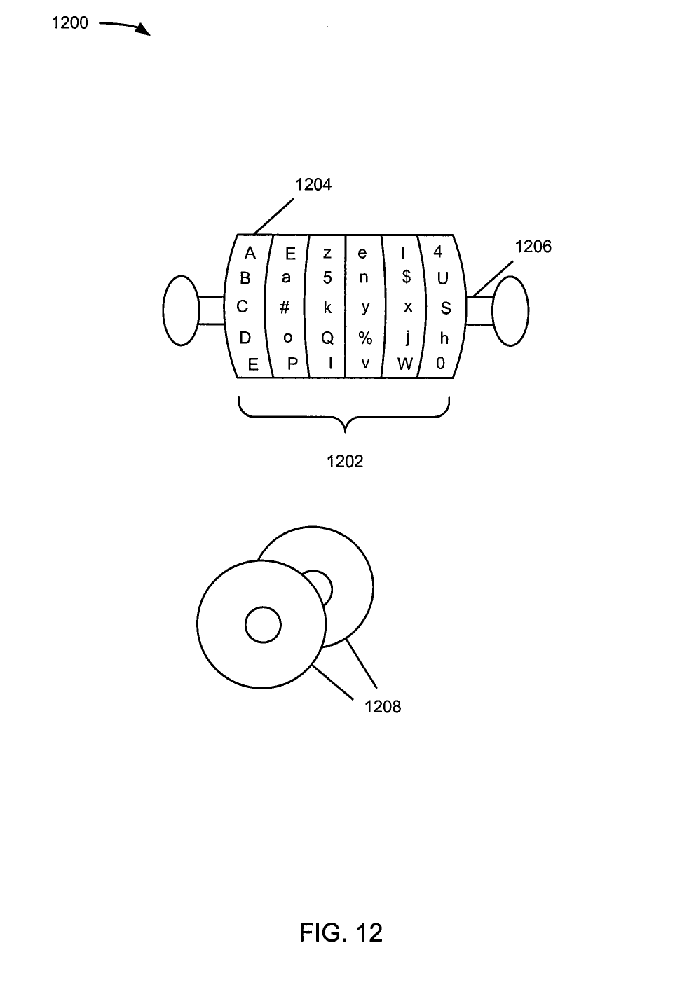

FIG. 12 depicts a diagram of an example of a device for generating and recovering passwords.

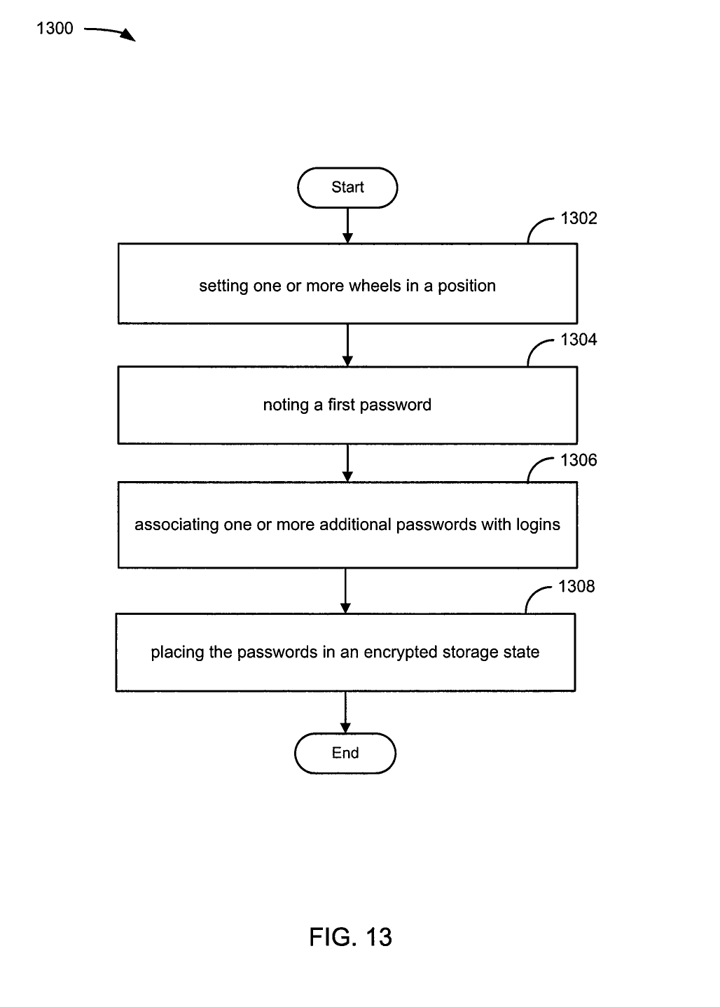

FIG. 13 depicts a flowchart of an example of a method for producing and using one or more passwords.

### DETAILED DESCRIPTION

In the following description, several specific details are presented to provide a thorough understanding. One skilled in the relevant art will recognize, however, that the concepts and techniques disclosed herein can be practiced without one or more of the specific details, or in combination with other components, etc. In other instances, well-known implementations or operations are not shown or described in detail to avoid obscuring aspects of various examples disclosed herein.

FIG. 1 depicts a diagram 100 of an example of a system for generating and recovering passwords. In the example of FIG. 1, diagram 100 includes a user 102 and a password generator and storage device.

In the example of FIG. 1, user 102 may be a person desiring to have secure passwords for one or more logins. User 102 may desire to carry the password generator and storage device 104 on her person. In a non-limiting example, the person may carry the password generator and storage device in her purse in a slot for a credit card.

In the example of FIG. 1, password generator and storage device 104 may be a mechanical device storing one or more passwords. The device may receive interactions from user 102. Any mechanical interaction known or convenient may be used to store or access passwords, and may include sliding, turning, twisting, and pushing. In a non-limiting example, a three dimensional interaction could be sliding, rotating, turning, pushing, pulling, depressing, clicking, or any interaction known or convenient.

In the example of FIG. 1, password generator and storage device 104 may have one or more mechanical inputs and outputs for receiving user interactions and producing passwords. Password generator and storage device 104 may have a plurality of password components inscribed on mechanical components of the password generator and storage device 104. The user 102 may store passwords by rearranging mechanical components to produce combinations of password components. Distinct patterns may be created and used as passwords.

A password component may be any letter(s), number(s), symbol(s), pictogram(s), braille markings, of any language, any number system, or any communicative method of marking known or convenient. In a non-limiting example, Japanese kanji are printed on mechanical components and passwords created by forming sets of the kanji; an example password could be [symbol] Advantageously, braille marking may make secure passwords available to the blind.

In the example of FIG. 1, in operation the user 102 interacts with mechanical components of the password generator and storage device 104 to select and produce passwords. The mechanical components may be arranged in any particular configuration that produces the passwords. The user 102 may remember one or more passwords, and then interact with the device to produce a password; all stored passwords may then simultaneously be produced. Advantageously, when the mechanical components are returned to any other configuration the passwords become un-ascertainable.

In the example of FIG. 1, in operation, the passwords may be assigned terms to relate them with their logins. In a non-limiting example, the term “email” may be assigned with a first password to assist the user in remembering the password. The terms may be inscribed on the device to assist the user in remembering the association of the password. The inscription may be done during manufacture of the device 104, or at a later time by the user 102.

FIG. 2 depicts a diagram 200 of an example of a device for generating and recovering passwords. In the example of FIG. 2, diagram 200 includes user 202, password generator and storage device 204, and plurality of passwords 212.

In the example of FIG. 2, user 202 may be a user as discussed in reference to FIG. 1. The person may have a need for secure passwords, but may have difficulty remembering secure passwords. The person may be able to carry a password generator and storage device on her person.

In the example of FIG. 2, password generation and storage device 204 includes input 206, output 208, and mechanical components 210.

In the example of FIG. 2, input 206 may be any mechanical input for interacting with the password generator and storage device 204. An example as discussed in reference to FIG. 4 would be the slides 404, or another example would be a rotating disc as discussed in reference to FIG. 9. Additionally, any mechanical input may be used.

In the example of FIG. 2, the output 208 may be visible to the user 202. The mechanical components 210 and the input 206 may be the same and may be viewed as the output 208. Alternatively, the output 208 may be separated from the mechanical components 210 and the input 206. The input 206 may be a separate set of mechanical components from mechanical components 210, and a user interacting with input 206 may indirectly interact with mechanical components 210.

In the example of FIG. 2, the mechanical components 210 may be any combination of plastic pieces, mechanical gears, rotating discs, three dimensional objects, two dimensional objects, cubes, or other parts that may be interacted with by user 202.

In the example of FIG. 2, plurality of passwords 212 includes key password 214, password two 216, and password n 218.

In the example of FIG. 2, key password 214 may be a password that the user 202 remembers to access the remaining passwords two through n. User 202 may remember key password 214. By adjusting the mechanical components 210 the password two 216 through the password n 218 may be viewed via the output 208.

In the example of FIG. 2, the password two 216 may be a secure password inaccessible to any person without the key password 214. There may be more than three passwords. Any number of passwords may be generated. The passwords may have length n of password components. In the example of FIG. 2, the password n 218 may be a password that is secured until key password 214 is entered.

In the example of FIG. 2, in operation, the password generator and storage device 204 receives an interaction from the user 202 with the mechanical components 210. In a non-limiting example, the user 202 may enter the key password 214 such as by adjusting mechanical components 210 to cause output 208 to display the key password 214 as well as all other passwords stored in the password generator and storage device 204 including the password two 216 and the password n 218. The production of the stored passwords may be simultaneous with the entry of the key password.

FIG. 3 depicts a flowchart 300 of an example of a method for producing one or more passwords. The method is organized as a sequence of modules in the flowchart 300. However, it should be understood that these and modules associated with other methods described herein may be reordered for parallel execution or into different sequences of modules.

In the example of FIG. 3, the flowchart 300 starts at module 302 with receiving a physical interaction from a person. The interaction may be sliding, rotating, turning, pushing, pulling, depressing, clicking, or any other interaction a person may use to cause mechanical components to be transposed.

In the example of FIG. 3, the flowchart 300 continues to module 304 with transposing one or more mechanical components. In interacting with the mechanical components, the user interaction may directly or indirectly transpose the mechanical components. That is to say that the user may, e.g., push a component, but the component may in turn push another component. In transposing, the mechanical components may move relative to each other.

In the example of FIG. 3, the flowchart 300 continues to module 306 with producing one or more passwords out from an encrypted state. Once mechanical components are transposed, password components may be displayed via an output in a different configuration than prior to transposing the mechanical components.

In the example of FIG. 3, the flowchart 300 continues to module 308 with receiving a second physical interaction that scrambles the passwords. The interaction may be any interaction including the interactions discussed in reference to module 304. In a non-limiting example, a user slides components completely into a base of a device both scrambling passwords and storing the components. Having produced one or more passwords, the flowchart terminates.

FIG. 4 depicts a diagram 400 of an example of a device for generating and recovering passwords. In the example of FIG. 4, diagram 400 includes base 402, slides 404, visible password components space 406, fixed password components 408, and inscriptions 412.

In the example of FIG. 4, base 402 may be constructed of polyvinylchloride, silica-filled polyolefin (such as may be known under the mark Teslin® available from PPG Industries of Pittsburg, Pa.) or any material known or convenient. The base 402 may be constructed of three layers, such as is discussed in reference to FIG. 6, or may be constructed as a single piece. The slide slots 414 may be available at either the top or the bottom of the base 402.

In the example of FIG. 4, slides 404 may be a rectangular unit formed of the same or a similar material to the base 402. Inscribed on the slides 404 may be one or more password components. For the purposes of FIG. 4, the slides are depicted as entering the base vertically from the top. However, the components may be vertically or horizontally printed. The orientation of the slides relative to the base may influence the orientation of password component printing. The slides 404 could be horizontally inserted into the base 402 from either the right or the left direction 402, or could be vertically printed and inserted into the base 402 from either the top or the bottom of the base 402.

In the example of FIG. 4, visible password components space 406 may be one of a plurality of spaces in the base 402 to allow password components to be viewed through the visible password component space 406. When inserted, the slides 404 are visible to through the visible password component space 406. Some or all of the password components may be visible depending on the position of the slides 404.

In the example of FIG. 4, fixed password components 408 may be directly inscribed on the base 408. The fixed password components 408 may not move, however, the slides 404 may move relative to the fixed password components 408.

In the example of FIG. 4, the inscriptions 412 may provide a user with a reference word to identify the passwords she has selected. A key password may be remembered that may or may not be used as a password for an account. In a non-limiting example the word e-mail may be inscribed to indicate password “A” is associated with an email account; similarly password “B” may have “network” inscribed to associate the password with a network login.

In the example of FIG. 4, the slide slots 414 may provide one or more spaces in the base 402 for the slides 404 to be inserted. If the base 402 is comprised of three layers, slots may be formed by removing portions of a middle layer so as to allow the slides 404 to move through the base 402. The middle layer may or may not be terminated on one end to prevent the slides 404 to pass all the way through the base 402. Such a termination may be on one side of the base 402, e.g., the top, the bottom, the left, or the right.

In the example of FIG. 4, in operation, the slides 404 are inserted into the base 402 using the slide slots 414. Some or all of the password components on the slides 404 may be visible through the visible password component spaces 406. The password components on the slides 404 may line up with the fixed password components 408 making stored passwords visible. Passwords may be identified using the inscriptions 412. The user may commit a first password to memory and slide the slides to cause the first password to appear. As password components on the slides are moved as well, all other stored passwords are produced. The user may enter secure passwords along with logins and gain entry to secure systems.

FIG. 5 depicts a diagram of an example of a device for generating and recovering passwords. FIG. 5 includes base 502, slides 504, and slide slots 506.

In the example of FIG. 5, the base 502 is oriented for entry of slides from the bottom of the base 502. The base may be constructed as is discussed in reference to FIG. 4 and FIGS. 6A-B. In the example of FIG. 5, slides 504 may be slides as discussed in reference to FIG. 4. The slides may enter through the base 502. In the example of FIG. 5, slide slots 506 may be slide slots as discussed in reference to FIG. 4 and FIG. 6. The slides 504 may enter the base 502 through the slide slots 506. In the example of FIG. 5, in operation, the slides 504 may be inserted vertically into the slide slots 506 in the base 502. Passwords may be viewed.

FIG. 6 depicts a diagram 600A of an example of unassembled parts of a password generator and storage device. FIG. 6A includes front 602, middle 604, back 606, and slide space 610, and visible password component space 614.

In the example of FIG. 6, front 602 may be created as a single piece. The piece may or may not have specific dimensions. In a non-limiting example, specific dimensions for the password generator and storage device may be as follows: the front 602, middle and back may measure 2 ⅛″×3⅜″.

In the example of FIG. 6, the front includes four visible password component spaces including the visible password component space 614. In a non-limiting example, the following specific dimensions may be observed. In the example of FIG. 6, the visible password components space may measure 7/32″×1 17/32″. The four visible password component spaces may be spaced ¼″ from each other and from the sides. The spaces may be spaced 5/32″ from the bottom of the front, and may be spaced 1 17/32″ from the top of the front. Any dimensions known or convenient may be used.

FIG. 6 further depicts a diagram 600B of a non-limiting example of unassembled parts of a password generator and storage device. Diagram 600B includes slide 612 and scoring mark 608. Slides may be prepared from a single sheet of material by scoring the material. In a non-limiting example, the following specific dimensions may be observed. The size of the sheet is 2⅛″×3 3/16″ including eight equally sized slides; a single slide being 17/64″×3 3/16″. A slide 612 may be separated from other slides by scoring the sheet and mechanically separating the slide from the sheet. A slide may be as thin or as thick as is known or convenient. Slides may be fewer than 31 mils thick. Any dimensions known or convenient may be used.

In the example of FIG. 6, the middle 604 may be attached to the back 606, and the front 602 attached to the middle 604. The slide 612 may be inserted into slide space 610. In a non-limiting example, the following specific dimensions may be observed. The slide space 610 may measure 11/64″, and slide space 610 may be 19/64″ spaced from the next slide space. Slide spaces in the middle may be uniform in size. To prevent slides from passing through the middle, the top end of the middle may be made of 5/32″ of material. When the front and the back are connected to the middle, the slides will have only one entry point, and may not pass through the middle. Any dimensions known or convenient may be used.

FIG. 7 depicts a diagram of an example of a side view of a device for generating and recovering passwords. In the example of FIG. 7, diagram 700 includes front 702, middle 704, back 706, and slide 708.

In the example of FIG. 7, the front 702, the middle 704, and the back 706 may be a front, a middle and a back as discussed in reference to FIG. 6, respectively. The slide 708 may be inserted and removed as is discussed in reference to FIG. 6. In a non-limiting example, the slide may be 17/64″, the slide spaces may be 19/64″, and the portion of the middle 704 between slide spaces may be 11/64″. Any dimensions known or convenient may be used.

FIG. 8 depicts a flowchart of an example of a method for producing and using one or more passwords. The method is organized as a sequence of modules in the flowchart 800. However, it should be understood that these and modules associated with other methods described herein may be reordered for parallel execution or into different sequences of modules.

In the example of FIG. 8, the flowchart 800 starts at module 802 with sliding one or more slides to one or more positions. A plurality of slides may be used in conjunction with a plurality of inscribed password components. In sliding the one or more slides, password components of the slides may line up with password components of the fixed inscriptions producing one or more passwords.

In the example of FIG. 8, the flowchart 800 continues to module 804 with noting a first password. The first password may be a key password. A user may later slide one or more slides into position to produce the key password as well as other stored passwords. The other stored passwords may be produced when the slides are moved because causing one password to appear will cause the other passwords to simultaneously appear.

In the example of FIG. 8, the flowchart 800 continues to module 806 with associating one or more additional passwords with logins. A user may inscribe a word associated with the login to remember the password. A first password component may be used to identify the word as associated with the login.

In the example of FIG. 8, the flowchart 800 continues to module 808 with inscribing a word associated with the one or more logins on a base. In a non-limiting example, “school” may be inscribed next to a third password to assist a user in remembering that the third password is associated with a school account.

In the example of FIG. 8, the flowchart 800 continues to module 810 with using a login and associated password. After viewing a password, a user who has difficulty in remembering a difficult password may use the password to gain access to an account.

In the example of FIG. 8, the flowchart 800 continues to module 812 with sliding one or more slides scrambling the passwords. Slides may be pushed, shifted, dragged, or otherwise physically moved causing the slides to enter a base. Advantageously, the passwords are scrambled when the slides are stored. Having used a password, the flowchart terminates.

FIG. 9 depicts a diagram of an example of a device for generating and recovering passwords. FIG. 9 includes base 902, plurality of wheels 904, and center wheel 906 and inscriptions 908 and key password 910.

In the example of FIG. 9, base 902 may be constructed of polyvinylchloride, silica-filled polyolefin (such as may be known under the mark Teslin® available from PPG Industries of Pittsburg, Pa.) or any material known or convenient.

In the example of FIG. 9, the plurality of wheels 904 may be stacked relative to each other such that the center of each of the plurality of wheels 904 is aligned on a single axis. All wheels may rotate freely, or may be turned a discrete number of degrees with a single turn. In the case of discrete numbers of degrees an audible click may be produced once a wheel has passed the specified number of degrees to identify a point at which the password components may be lined up.

In the example of FIG. 9, the center wheel 906 may specify a password component associated with an inscription of the inscriptions 908. The specified password component may identify an inscribed word or phrase that associates the password with the account the password is used to unlock.

In the example of FIG. 9, the inscriptions 908 may associate one or more logins with one or more passwords. A user may use the inscriptions 908 to identify a password associate with a login to an account.

In the example of FIG. 9, the key password 910 may be a password a user may remember to use to gain access to all other stored passwords. The password may include a component “A” associated with “A” of inscriptions 908.

In the example of FIG. 9, in operation, a user may interact with the plurality of wheels 904 to produce one or more passwords associated with accounts by the inscriptions 908.

FIG. 10 depicts a flowchart of an example of a method for producing and using one or more passwords. The method is organized as a sequence of modules in the flowchart 1000. However, it should be understood that these and modules associated with other methods described herein may be reordered for parallel execution or into different sequences of modules.

In the example of FIG. 10, the flowchart 1000 starts at module 1002 with rotating a disc to a position. One or more discs may be set to various positions. The discs may have password components inscribed on them. When the discs are rotated password components located on separate discs may be aligned so as to form passwords including the password components on various discs.

In the example of FIG. 10, the flowchart 1000 continues to module 1004 with noting a first password. The first password may be a password used to set all other passwords. A user may remember a first password and then when recovering passwords, may rotate discs to positions to display the first password as well as all other passwords stored in the device.

In the example of FIG. 10, the flowchart 1000 continues to module 1006 with associating one or more additional passwords with logins. In a non-limiting example, a user may decide to associate an email login with a first password, a work computer login with a second password and any other account with an nth password.

In the example of FIG. 10, the flowchart 1000 continues to module 1008 with inscribing a word associated with the one or more logins on a base. The user may inscribe a word used to associate a login with a password.

In the example of FIG. 10, the flowchart 1000 continues to module 1010 with using a login and associated password. A user may enter a password associated with the login to gain access to a secure system.

In the example of FIG. 10, the flowchart 1000 continues to module 1012 with placing the passwords in an encrypted storage state. In a non-limiting example, discs are rotated to arbitrary positions scrambling passwords. Having placed the passwords in an encrypted storage state, the flowchart terminates.

FIG. 11 depicts a diagram 1100 of an example of a device for generating and recovering passwords. The diagram includes password generation and storage device 1102, magnetic strip 1104, and optional embedded chip 1106.

In the example of FIG. 11, password generation and storage device 1102 may be a password generation and storage device as discussed above. Additionally, password generation and storage device 1102 may be associated with a line of credit. Magnetic strip 1104 and optional embedded chip 1106 could be associated with the line of credit and be used to facilitate the use of the line of credit.

In the example of FIG. 11, magnetic strip 1104 could be a magnetic strip having multiple tracks storing data associated with a line of credit. The card when passed through a magnetic card reader could provide such data associated with the line of credit to a merchant in facilitating a purchase using the line of credit.

In the example of FIG. 11, embedded chip 1106 could be an integrated circuit such as is used in an integrated circuit card (ICC), smart card, or any card having an embedded integrated circuit which could store data or process information. Embedded chip 1106 could be used to process financial transactions. Embedded chip 1106 could be used to store data.

FIG. 12 depicts a diagram 1200 of an example of a device for generating and recovering passwords. Diagram 1200 includes plurality of wheels 1202, password identifying wheel 1204, spindle 1206, and extra wheels 1208.

In the example of FIG. 12, plurality of wheels 1202 have password components inscribed on edges, and may be rotated to many possible combinations. Password components on the edges line up producing passwords. Any number of wheels known or convenient may be used.

In the example of FIG. 12, password identifying wheel 1204 includes a plurality of password components for identifying one or more login accounts. A login may be associated with a password component of the password identifying wheel 1204. A user may identify the password by the first password component on the password identifying wheel 1204. The password identifying wheel 1204 may be the first wheel on the left, the last wheel on the right or any other known or convenient location. More than one password identifying wheel may be used. In a non-limiting example, a first wheel and a last wheel may be used to identify passwords.

In the example of FIG. 12, spindle 1206 may be passed through the centers of the plurality of wheels 1202. Spindle 1206 may be any rod, bar, or other cylindrical device for plurality of wheels 1202. Spindle 1206 may be terminated on either or both ends in so as to prevent the plurality of wheels 1206 from falling off of spindle 1206. One or more of the terminated ends of the spindle 1206 may be removable so as to allow for the addition and removal of one or more of the plurality of wheels 1202.

In the example of FIG. 12, in operation, the plurality of wheels 1202 are placed on spindle 1206, and rotated so as to cause password components to line up producing a plurality of passwords. A user may remember a first password. The user may place the plurality of wheels in an encrypted storage state by turning the wheels in a random manner. In retrieving the passwords, the user may line up the first password one component per wheel. All other stored passwords will be concurrently retrieved.

FIG. 13 depicts a flowchart 1300 of an example of a method for producing and using one or more passwords. The method is organized as a sequence of modules in the flowchart 1300. However, it should be understood that these and modules associated with other methods described herein may be reordered for parallel execution or into different sequences of modules.

In the example of FIG. 13, the flowchart starts at module 1302 with setting a wheel in a position. A wheel may be turned to a position producing a password. One or more wheels may be turned as needed.

In the example of FIG. 13, the flowchart continues to module 1304 with noting a first password. A first password may be used to produce stored passwords from an encrypted storage state.

In the example of FIG. 13, the flowchart continues to module 1306 with associating one or more additional passwords with logins. The additional logins may be associated with individual password components of the first wheel.

In the example of FIG. 13, the flowchart continues to module 1308 with placing the passwords in an encrypted storage state. This may be accomplished by turning wheels in a random fashion to scramble passwords. Having placed the passwords in an encrypted storage state, the flowchart terminates.

It will be appreciated to those skilled in the art that the preceding examples are not limiting in scope. It is intended that all permutations, enhancements, equivalents, and improvements thereto that are apparent to those skilled in the art upon a reading of the specification and a study of the drawings are included within the true spirit and scope of these teachings. It is therefore intended that the following appended claims include all such modifications, permutations, and equivalents as fall within the true spirit and scope of these teachings.

What is claimed is:

1. A mechanical password generation and storage device comprising:
an input, wherein, in operation, the input receives an interaction;
an output, wherein, in operation, the output displays one or more passwords; and
a plurality of mechanical components at least partially visible via the output;
wherein, in operation, the interaction transposes one or more of the mechanical components at the input to produce a key password, component by component, simultaneously producing all other stored passwords via the output;

2. The device of claim 1 wherein the plurality of mechanical components includes at least two mechanical components and one or more of the mechanical components is fixed in place, and one or more of the mechanical components may be transposed.

3. The device of claim 1 wherein the mechanical components include a card having one or more slides and the input is an upward or downward movement of one or more of the slides.

4. The device of claim 1 wherein the mechanical components have password components inscribed on the mechanical components.

5. The device of claim 1 wherein the device is sized suitable for storage in a location designed for a credit card.

6. A method for generating passwords comprising:
receiving a physical interaction with one or more mechanical components;
transposing one or more mechanical components to produce a first password; and
producing one or more passwords.

7. The method of claim 6 wherein the mechanical components are slides printed with password components, and transposing includes sliding the slides allowing password components to line up producing the passwords.

8. A mechanical device comprising:
a base having a plurality of slots having password components printed on the base; and
a plurality of slides having password components printed on the slides;
wherein, in operation, the plurality of slides are inserted into the plurality of slots causing password components of the base to line up with password components of the slides;
whereby a user inputs a first password, producing the first password along with all stored passwords.

9. The mechanical device of claim 8 wherein the slides have password components are printed vertically on the slides.

10. The mechanical device of claim 8 wherein the base has a dimension of 3.375 inches by 2.125 inches.

11. The mechanical device of claim 8 wherein the base is 30 to 90 mils thick.

12. The mechanical device of claim 8 wherein the slides are fewer than 31 mils thick.

13. The mechanical device of claim 8 wherein the plurality of slides includes four slides.

14. The mechanical device of claim 8 wherein, the base and slides are constructed of polyvinyl chloride or silica-filled polyolefin.

15. A device for generating and storing passwords comprising:
a base having:
password components inscribed on the base,
one or more visible password component spaces, slide slots, and
inscriptions associating passwords with login accounts; and
slides having password components inscribed on the slides.

16. The device of claim 15 wherein the base has a top and a bottom, and the slides vertically enter the base at the bottom into the slide slots displaying password components through the one or more visible password component spaces.

17. The device of claim 15 wherein the base has a top and a bottom, and the slides vertically enter the base at the top into the slides slots.

18. The device of claim 15 wherein the slides enter the slide slots horizontally from the left.

19. The device of claim 15 wherein the slides enter the slide slots horizontally from the right.

20. The device of claim 15 wherein the password components include uppercase letters of the English alphabet.

21. The device of claim 15 wherein the password components include numbers.

22. The device of claim 15 wherein the password components include pictograms.

23. A device for generating and storing passwords comprising:
means for displaying physically movable password components;
means for displaying fixed password components, wherein the physically movable password components are moved to display a first password, simultaneously producing stored passwords; and
means for storing the physically movable password components, wherein storing the physically movable password components scrambles the passwords.
